(19) United States
(12) Patent Application Publication
(10) Pub. No.: US 2018/0060439 A1
(43) Pub. Date: Mar. 1, 2018

(54) USER STATUS UPDATE SUGGESTIONS

(71) Applicant: Facebook, Inc., Menlo Park, CA (US)

(72) Inventors: Matthew Randall Kula, San Francisco, CA (US); Chieh Ho, Sunnyvale, CA (US)

(21) Appl. No.: 15/247,658

(22) Filed: Aug. 25, 2016

(51) Int. Cl. G06F 17/30; H04L 12/58

(52) U.S. Cl. CPC G06F 17/30867; G06F 17/30528; H04L 51/32

(57) ABSTRACT

In one embodiment, a method includes, for each of several first users of an online social network, accessing a social graph maintained by an online social-networking system, the social graph comprising nodes and edges. The method further includes generating a suggestion to post a user status update comprising content related to an event. The method further includes, for each of the first users, determining a conversion score for the first user based at least in part on one or more second nodes that are connected by an edge to a first node corresponding to the first user, wherein the conversion score represents a probability that the first user will adopt the suggestion to post a user status update comprising the content related to the event. The method further includes for each of the first users with a conversion score above a threshold score, sending the suggestion to the first user.

### TECHNICAL FIELD

This disclosure generally relates to sending user status prompts to users of an online social network.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

In particular embodiments, a social-networking system may prompt one or more users to post a status update in relation to an event. When an event is about to take place or is currently taking place, the social network may prompt a user to update her status to say something about the event. For example, the social network may send a user, Jessica, a prompt that the Golden State Warriors (an NBA basketball team) are on the verge of breaking the single season winning record with their 73rd win. The social network may present a first user interface with a prompt that may state, “Jessica, the Warriors are about to make history. Let your friends know you're watching.” The prompt may further include an option to post the score or other features to the post. When Jessica selects the “post” icon, the social network may post that Jessica is watching the game. The post may be viewable by different users of the online social network, depending on Jessica's privacy settings.

To determine to whom to send prompts, the social-networking system may perform various machine learning techniques to determine which users have the highest probability of posting in response to the prompt. The factors that the machine learning program may consider include, among other factors: whether the user has liked a particular team or more than one team; the time of day; the time remaining in the event; the time prior to the event, the outcome of the event (e.g., who won the game); the nature of the event as it relates to the user's likes and activities; the importance of the event; the amount of people talking about or viewing the event; the intensity of the event (e.g., the score of a game); and how many of the users friends have liked the event or entities related to the event (e.g., a particular sports team).

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2 illustrates an example user interface for prompting a user to post a user status update.

FIG. 3 illustrates an example user interface of a user status suggestion.

FIG. 4 illustrates an example user interface for prompting a user to post temporary profile picture.

FIG. 5 illustrates an example user interface for selecting a temporary profile picture.

FIG. 6 illustrates an example user interface for prompting a user to post a user status update.

FIG. 7 illustrates an example social graph.

FIG. 8 illustrates an example method for prompting a user to post a user status update.

FIG. 9 illustrates an example computer system.

### DESCRIPTION OF EXAMPLE EMBODIMENTS

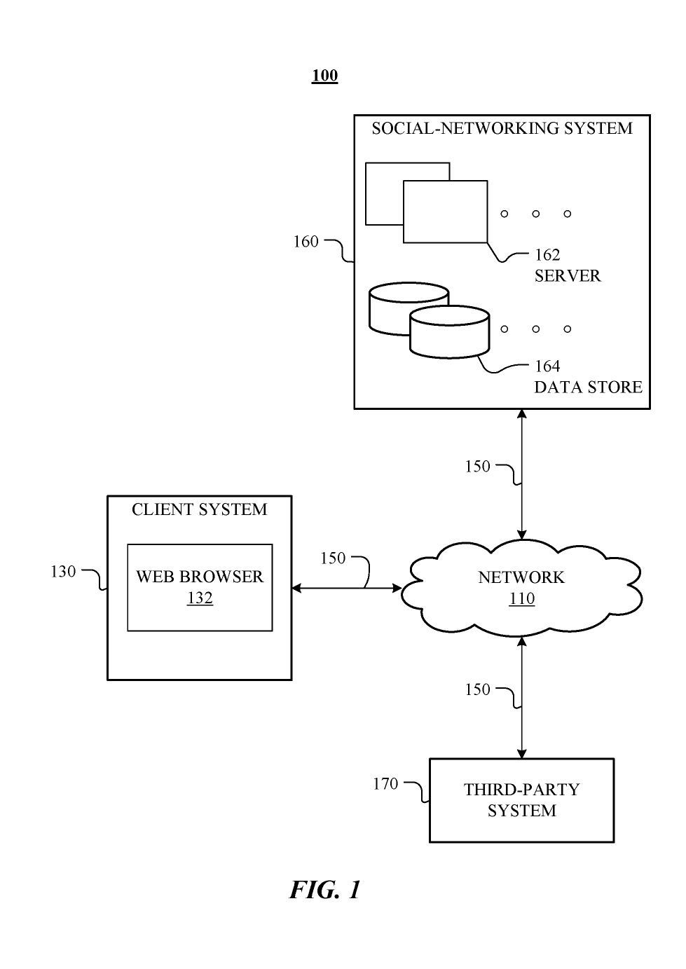

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of client system 130, social-networking system 160, third-party system 170, and network 110, this disclosure contemplates any suitable arrangement of client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client system 130, social-networking systems 160, third-party systems 170, and networks 110.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 130. A client system 130 may enable a network user at client system 130 to access network 110. A client system 130 may enable its user to communicate with other users at other client systems 130.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. As an example and not by way of limitation, client system 130 may access social-networking system 160 using a web browser 132, or a native application associated with social-networking system 160 (e.g., a mobile social-networking application, a messaging application, another suitable application, or any combination thereof) either directly or via network 110. In particular embodiments, social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. Social-networking system 160 may provide users of the online social network the ability to communicate and interact with other users. In particular embodiments, users may join the online social network via social-networking system 160 and then add connections (e.g., relationships) to a number of other users of social-networking system 160 to whom they want to be connected. Herein, the term “friend” may refer to any other user of social-networking system 160 with whom a user has formed a connection, association, or relationship via social-networking system 160.

In particular embodiments, social-networking system 160 may provide users with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160 and coupled to social-networking system 160 via a network 110.

In particular embodiments, social-networking system 160 may be capable of linking a variety of entities. As an example and not by way of limitation, social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 160 also includes user-generated content objects, which may enhance a user's interactions with social-networking system 160. User-generated content may include anything a user can add, upload, send, or “post” to social-networking system 160. As an example and not by way of limitation, a user communicates posts to social-networking system 160 from a client system 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof. In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client systems 130 or one or more third-party system 170 via network 110. The web server may include a mail server or other messaging functionality for receiving and routing messages between social-networking system 160 and one or more client systems 130. An API-request server may allow a third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of social-networking system 160. A privacy setting of a user determines how particular information associated with a user can be shared. The authorization server may allow users to opt in to or opt out of having their actions logged by social-networking system 160 or shared with other systems (e.g., third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

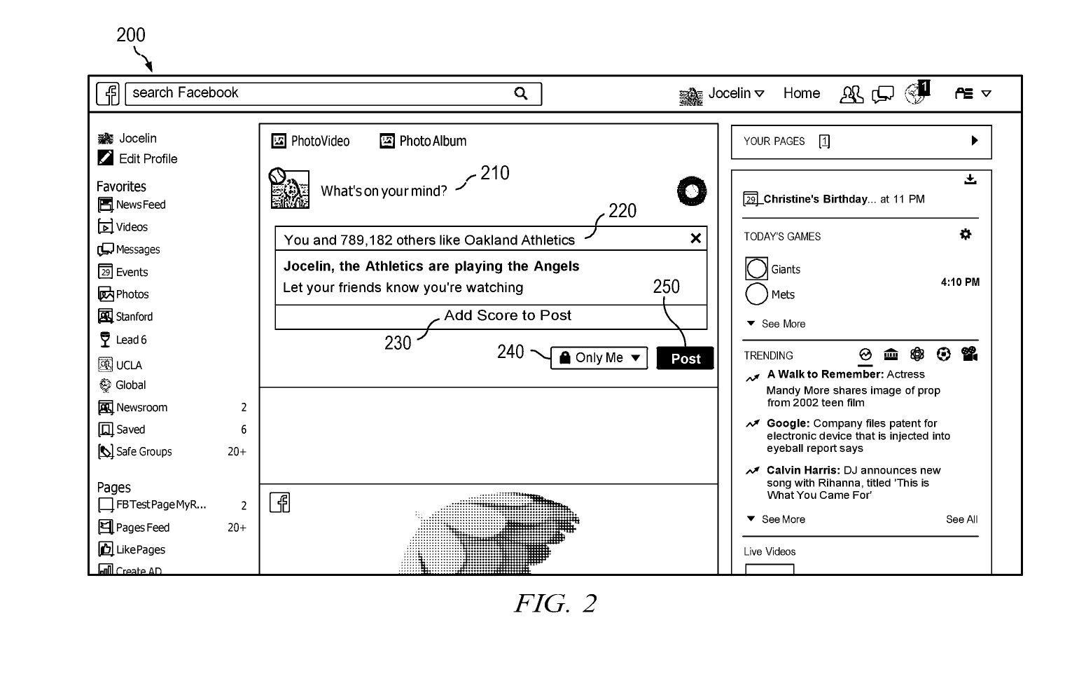

FIG. 2 illustrates an example user interface 200 for prompting a user to post a user status update. User interface 200 may be sent before an event has begun or while an event is occurring. User interface 200 may be a user interface for an online social network that displays a user's newsfeed and other information. For example, a user, Jocelin, may be a user of the online social network having a user profile and user interface 200 may be a user interface associated with Jocelin's user profile. User interface 200 may include a user status update field 210, a user status suggestion 220, a post add-on 230, a visibility icon 240, and a post icon 250. User status update field 210 may be a location on the user interface 200 wherein the user may post user status updates. For example and not by way of limitation, a user, Jocelin, may post a status update in user status update field 210 that states: “Hiking the Grotto with my family!” (the Grotto is a hiking destination in Utah). The status update may include a photo of Jocelin and her family in front of a waterfall at the Grotto. The status update may also include one or more tags or other suitable metadata, such as friend tags and geo-location tags. In particular embodiments, social-networking system 160 may send user status suggestion 220 to one or more users of the online social network. As an example and not by way of limitation, social-networking system 160 may send user status suggestion 220 to Jocelin to prompt her to update her status. User status suggestion 220 may be sent because social-networking system 160 has identified an event that Jocelin may be interested in. User status suggestion 220 may be related to any event, including, but not limited to, sporting events, local or nationwide elections, natural occurring phenomena (e.g., storms, earthquakes, floods), television shows and premieres, movie releases, game releases, application launches (e.g., the launch of Pokémon Go in the APPLE app store), holidays, musical events, and any other suitable event. Continuing the example, social-networking system 160 may send user status suggestion 220 to Jocelin that states: “Jocelin, the Athletics are playing the Angels. Let your friends know you're watching.” Jocelin may view user status suggestion 220 and select to post the associated text string by selecting post icon 250. Jocelin may also add her own comments in user status update field 210. As an example and not by way of limitation, Jocelin may add the following comment to the user status suggestion 220: “Let's GO A's!” Jocelin may also have the option to add other information to her post by selecting post add-on 230. Post add-on 230 may include the option to post information about the event. As an example and not by way of limitation, if the event is a baseball game, post add-on 230 may state: “Add score to post.” If the user selects post add-on 230, the score may be added to the post. The score may update in real-time as each team scores more runs. Instead of adding the score, post add-on 230 may provide an option to add key statistics, such as the number of strikeouts A's pitcher Sonny Gray has so far in the game. As another example, if the event is a presidential election debate, post add-on 230 may state, “Add a quote from one of the candidates.” If the user selects post add-on 230, one or more quotes from one or more candidates may be displayed for the user to select and post in conjunction with user status suggestion 220. The user may also select how visible the post will be by selecting visibility icon 240. As an example and not by way of limitation, Jocelin may elect that user status suggestion 220, once posted, will be visible only by her, only by her friends, only by her friends and their friends, or by any user of the online social network.

In particular embodiments, the event may be a sporting event, a scheduled television broadcast, or a live event. As mentioned above, user status suggestion 220 may be related to any event, including, but not limited to, sporting events, local or nationwide elections, natural occurring phenomena (e.g., storms, earthquakes, floods), television shows and premieres, movie releases, game releases, application launches (e.g., the launch of Pokémon Go in the APPLE app store), holidays, musical events, and any other suitable event. In particular embodiments, user status suggestion 220 may be sent to a user before an event has begun, during the event, or after the event has concluded.

To determine which users of the online social network to send user status suggestion 220 to, social-networking system 160 may, for each of a plurality of users of the online social network, access a social graph maintained by social-networking system 160. The social graph may comprise a plurality of nodes and a plurality of edges connecting the nodes. A first node of the plurality of nodes may correspond to a first user of the plurality of users. The social graph may comprise one or more second nodes; each of these may correspond to a second user, an entity, or a content object. At least some of the second nodes may be connected by an edge to the first node. Each edge may represent a relationship between two nodes. As an example and not by way of limitation, a user Alex may be represented by a first node in a social graph. The social graph may also include several second nodes. Each of these nodes may correspond to other users (e.g., Ali, Blake, and Stephanie), entities (e.g., the Oakland Athletics; the Republican National Convention; the Kennedy Center in Washington, D.C.; Tulsa, Okla.), or content objects (e.g., a video of Jimmy Fallon performing a song with the Roots; a blog post about an upcoming Supreme Court case; a photo of Shaquille O'Neal). Alex may have various types of relationships with these users, entities, and content objects. As an example and not by way of limitation, Alex may be married to Ali, and may be friends with Blake and Stephanie; Alex may have “liked” the Oakland Athletics, may have “watched” the Republican National Convention, and may have “checked-in” at the Kennedy Center in Washington D.C. when he went with Ali to see Phantom of the Opera. Each of these relationships may be represented by an edge connecting the node corresponding to Alex, along with an indication of the type of relationship he has with each of these users, entities, or content objects. As stated previously, social-networking system 160 may access the social graph for each of a plurality of users of the online social network. Social-networking system 160 may use the information in the users' social graphs to determine whether a given user is likely to convert on a user status suggestion.

Either after or before accessing the social graph, social-networking system 160 may identify an event candidate that social-networking system 160 may base a user status suggestion. The event candidate may be any suitable event, as discussed previously. The social-networking system may identify event candidates by monitoring Rich Site Summary (RSS) feeds, various schedules of various sports teams and other organizations, television programming, and governmental calendars among other things. Event data may be gathered manually or automatically by a server of social-networking system 160. As an example and not by way of limitation, social-networking system 160 may access the season schedule of the Oakland Athletics (a Major League Baseball team), along with the television schedule of the Oakland Athletics. Social-networking system 160 may then identify which games will be televised in a given user's geographic location, and may identify one or more games as event candidates. In particular embodiments, not every game may be identified as an event candidate; only particularly important games may be identified. Determining which events (e.g., games) are particularly important may depend on a given user's social graph information. As an example, social-networking system 160 may determine that a user Alex has a strong affinity to the Oakland A's, but has an even stronger affinity to the Oakland A's when they play the A's′ cross-town rivals, the San Francisco Giants. Social-networking system 160 may identify the A's-Giants game as an event candidate because the information in Alex's social graph indicates that he will likely watch this game and post about the game on the online social network.

In particular embodiments, social-networking system 160 may generate a suggestion to post a user status update comprising content related to the event candidate. The suggestion to post a user status update may be based on user status suggestion 220. The suggestion to post a user status update may be generated automatically by social-networking system 160. To accomplish this, social-networking system 160 may determine the type of event based on the title of the event, or alternatively, on metadata associated with the event information in the RSS feed or other suitable information data source. As an example, a scheduled Oakland A's game may be titled “Oakland Athletics vs. San Francisco Giants,” and may also be accompanied by one or more tags that say “MLB,” “Baseball,” or some similar tag. Using the title of the event, the associated metadata, or a combination of both, and using natural language processing, or by using a lookup table, social-networking system 160 may automatically determine that the scheduled Oakland A's game is a baseball game. Social-networking system 160 may provide text strings to populate user status suggestion 220.

In particular embodiments, social-networking system 160 may, for each of the plurality of users, determine a conversion score for the user based at least in part on one or more of the second nodes that are connected by an edge to the first node. The conversion score may represent a probability that the user will adopt the suggestion to post a user status update comprising the content related to the event. The user status update comprising the content related to the event may be based on user status suggestion 220. In particular embodiments, the conversion score may be determined by a machine-learning model that may determine which users have the highest probability of adopting user status suggestion 220. Factors that the machine-learning model may consider when determining the conversion score for a particular user may include whether the user has liked a particular entity associated with the event; the time of day of the event; the time of day that user status suggestion 220 will be sent to the user; the time remaining in the event; the amount of time until the event begins; the outcome of the event (e.g., who won the baseball game); the nature of the event as it relates to the user's likes and social networking activity; the importance of the event, either to the user or to the general public; the amount of people talking about or viewing the event; the intensity of the event (e.g., if the event is a basketball game, whether the game is close or not); whether the user has adopted a user status suggestion in the past; the frequency with which the user posts user status updates; and the number of the user's friends have liked the event or entities or content objects related to the event.

In particular embodiments, the conversion score may be calculated by measuring an affinity coefficient between the first node and each of the one or more second nodes, wherein the affinity coefficient represents a strength of a relationship between two nodes, and applying one or more weighting factors to each of the affinity coefficients. Any interaction that a user makes with any entity or concept on the online social network may affect the affinity coefficient between the user and whatever entity or concept the user is interacting with. In particular embodiments, the affinity coefficient may be based on the user liking, sharing, commenting on, or clicking on a content object corresponding to a concept node corresponding to a concept related to the event. As an example and not by way of limitation, if a user likes the Golden State Warriors, an NBA basketball team, the affinity coefficient between the user and the entity Golden State Warriors may increase. As another example, if the user reads an article on the online social network about SPACEX, the affinity coefficient between the user and SPACEX may increase. In particular embodiments, the user's first and second degree connections may affect the affinity coefficient for the user and whatever concept or entity the user's friends are interacting with. As an example and not by way of limitation, if a threshold portion of a user's friends post, like, and comment on content objects related to James Corden (a British comedian and talk show host), the affinity coefficient between the user and James Corden may increase. When the social-networking system has identified an event, it may access the second nodes corresponding to concepts related to the event, and access the user's affinity coefficient with those second nodes. As an example and not by way of limitation, if the event is a forecasted hurricane about to hit the East Coast of the United States, the social-networking system may access the social graphs of a plurality of users, and may access second nodes (e.g., concept nodes) related to the particular hurricane or hurricanes in general. A user, Alex, may have posted an article about the particular hurricane and thereby increased the affinity coefficient between the concept node corresponding to the hurricane and the user node corresponding to himself. Social-networking system 160 may consider other factors, such as Alex's geo-location: if Alex lives closer to where the hurricane will hit, the affinity coefficient between Alex's user node and the concept node corresponding to the hurricane may increase.

Social-networking system 160 may take the affinity coefficients between the user and various related second nodes and apply one or more weighting factors to the affinity coefficients, based on the type of interaction the user has made with the concepts corresponding to the second nodes. As an example and not by way of limitation, viewing a particular content object may be given a first weighting factor, liking a particular content object may be given a second weighting factor, and posting a particular content object may be given a third weighting factor. The exact weighting factors to be assigned to particular types of interactions may be determined by the machine-learning model, or by an administrator of social-networking system 160. In particular embodiments, the conversion score may represent a sum of the product of each affinity coefficient and its respective weighting factor. Thus, a conversion score CS may be expressed in the following formula:

CS=aw₁+bw₂+cw₃+dw₄+ . . .

where a, b, c . . . represent affinity scores for different types of interaction with content objects and w₁, w₂, w₃ . . . represent the different weighting factors assigned to each type of interaction.

In particular embodiments, the weighting factors may be determined by a machine learning model comprising a plurality of inputs, wherein the plurality of inputs comprise: a time of day that the event occurs, whether the first user has previously adopted a suggestion to post a user status update, an affinity score between the first node and a second node corresponding to the event, a frequency with which the first user posts user status updates, or any other suitable factor, many of which are discussed herein.

In particular embodiments, the weighting factors may be determined at least in part by an affinity coefficient between the first node and a second node corresponding to the event, and at least one sub-event occurring within the event. As an example and not by way of limitation, an event may be an NBA basketball game. A sub-event within the event may be the game going into overtime. When the game goes into overtime, the weighting factors may be increased, having the effect of increasing the conversion score. This may push some users over the threshold conversions score; thus, more user status suggestions may be sent. Thus, the sub-event within the event may increase the conversion score because users may be more likely to adopt a user status suggestion if a sub-event occurs, especially if the sub-event makes the event more exciting.

In particular embodiments, social-networking system 160 may, for each user with a conversion score above a threshold score, send the suggestion to the user. This may be accomplished by sending a user status suggestion similar to user status suggestion 220 to each user with a conversion score above a threshold score. Each user with a conversion score above a threshold score may receive the suggestion (e.g., user status suggestion). The user status suggestion may address the user by name, announce the event, and invite the user to adopt the user status suggestion.

As an example and not by way of limitation, suppose the company SPACEX is planning an event where the company launches their Falcon 9 rocket into orbit and attempts to land the rocket on an unmanned ship in the ocean. The event may be scheduled to take place on a Tuesday evening in April. SPACEX may publicize the event and notify various news organizations about the event so that the event appears on various RSS feeds, schedules, and calendars. Social-networking system 160 may discover the event via these RSS feeds, schedules, and calendars and may generate a user status suggestion for this event. This user status suggestion may say “SpaceX is about to launch the Falcon 9 rocket into space. Let your friends know you're watching the live stream.” Before or after identifying the event and generating the user status suggestion, social-networking system 160 may also identify users to whom it may send the user status suggestions regarding the SPACEX event. To make the identification, social-networking system 160 may identify only those users who are likely to post about the event. To accomplish this, social-networking system 160 may gather information about the event from various data sources, including user posts, tags, followers of entities related to the event, and other suitable data sources.

Continuing the above example, social-networking system 160 may determine that the event is associated with SPACEX and that SPACEX designs, manufactures, and launches rockets and spacecraft. From this it may determine various subjects with which to associate the SPACEX event. The subjects may take the form of tags that may be associated with the event. Example tags associated with the SPACEX event could include “spacex,” “rockets,” “falcon9,” “elonmusk,” “space,” and similar tags. Social-networking system 160 may also calculate conversion scores for users by accessing their social graph information, as discussed above. In this example, social-networking system may access users' social graph information and calculate conversion scores for one or more users. Doing this may help social-networking system 160 identify users that may be likely to post about the SPACEX event. These could be users who are interested in outer space, space exploration, SPACEX itself, Elon Musk (the founder of SPACEX), or any other suitable factor related to the event. Each of these concepts may be represented by concept nodes in the social graph and may be connected to one or more users by an edge connecting the concept nodes to the users. Users whose user nodes have many edges connecting to concept nodes related to the SPACEX event may be more likely to adopt a user status suggestion related to the SPACEX event than users who have fewer edges connecting to related concept nodes. Thus, such users may receive higher conversion scores than other users.

In conjunction with accessing and analyzing the users' social graph information, social-networking system 160 may also consider other factors in determining the conversion score for a particular user. Continuing the example, suppose a user, Max, frequently posts user status updates related to SPACEX, space travel, technology, or other similar subjects. The social-networking system may access Max's past posts and determine that he is likely to post user status updates related to SPACEX. Thus, Max may receive a higher conversion score than he would if he did not post as frequency. On the other hand, consider a user, Samantha, who frequently likes content objects related to SPACEX (e.g., an article about SPACEX, a video of a rocket launch), but who rarely posts user status updates. Because Samantha rarely posts user status updates, her conversion score may be lower than if she posted user status updates frequently. This may be because Samantha would be unlikely to adopt a user status suggestion from social-networking system 160. Once social-networking system 160 calculates a conversion score for each of a plurality of users, it may send the user status suggestion it generated for the SPACEX event to each of the users whose conversion score meets or exceeds a threshold score. This threshold score may be predetermined by an administrator of social-networking system 160, or may be determined dynamically by the machine-learning model. The machine-learning model may receive as feedback, the actual conversion rates for each user and for each event. The machine-learning model may take these actual conversion rates for each user and for each event and use them as input to the machine-learning model in order to make better predictions in the future about which users are likely to adopt a user status suggestion.

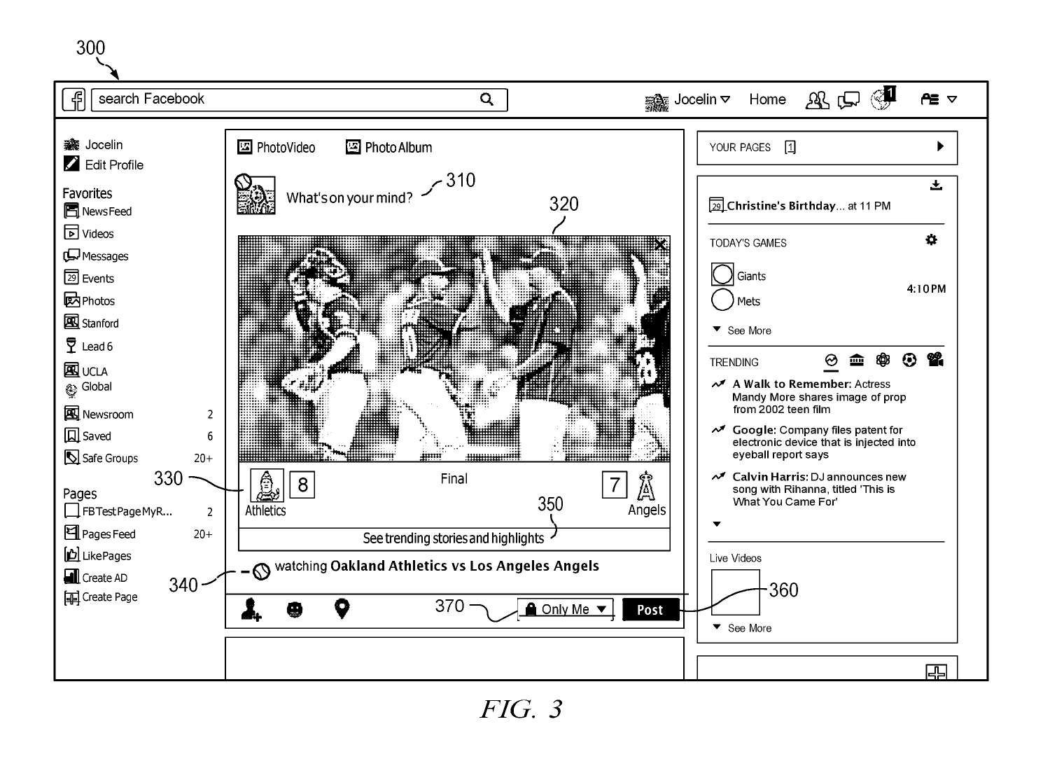

FIG. 3 illustrates an example user interface 300 of a user status suggestion. In particular embodiments, social-networking system 160 may additionally receive an indication that a user has adopted the suggestion to post a user status update comprising content related to the event (e.g., a user status suggestion similar to user status suggestion 220), and may update a status element of the first user with the content related to the event. The status element may be user status update field 310. The content related to the event may comprise one or more images, text strings, and minutiae related to the event. With reference to the example user interface 300 of FIG. 3, user interface 300 may include user status update field 310, content object 320, main information 330, minutiae 340, additional information icon 350, and post icon 360. User interface 300 may be displayed after a user selects post icon 250 in FIG. 2. User interface 300 may display for a user's review substantially what will be posted when the user selects post icon 360. Content object 320 may comprise images, video, text, or any suitable content object or any combination thereof. Content object 320 may be produced automatically by social-networking system 160, or may be selectable by the user. Main information 330 may comprise a main summary or description of the event, including a major headline of the event, the score of the event if the event is a sporting event, or any other suitable information. Minutiae 430 may comprise the user's sentiment or activity during the event. In particular embodiments, minutiae may include metadata that a user may add to a post. Examples of minutiae include “I'm feeling . . . ” or “I'm watching . . . ” and the user may fill in the minutiae with various options, such as “happy” in the case of “I'm feeling . . . ” In the case of “I'm watching . . . ” the user may fill in the minutiae with whatever the user is watching, such as a television show. Social-networking system 160 may then take the minutiae and add relevant images and other related content. As an example and not by way of limitation, if a user Jessica posts minutiae stating “watching The Walking Dead,” social-networking system 160 may automatically add a photo of The Walking Dead to Jessica's post. Additionally, if Jessica posts minutiae stating “watching the Golden State Warriors,” the social-networking system may add a photo that was taken during the course of the game, along with the current score of the game. The social-networking system may also add stats or other relevant information.

As an example and not by way of limitation, if an event is the Oakland A's vs. the Los Angeles Angels, and a user adopts user status suggestion 220 and posts content object 320, main information 330, and additional information 340, the user may additionally include minutiae 340, which may state, “watching Oakland Athletics vs Los Angeles Angels.” If the event is a rocket launch by SPACEX, the minutiae may state “watching the SpaceX Falcon 9 rocket launch,” or something related to the user's sentiment, such as “feeling nervous,” “feeling excited,” and other suitable statements. Using visibility icon 370, the user may select who will be able to view her post (e.g., only the user, only the user's friends, only the user's friends and their friends, or all users of the online social network). Once the user is satisfied with how the post will look, what information is presented, and the post's visibility, the user may post the content related to the event by selecting post icon 360.

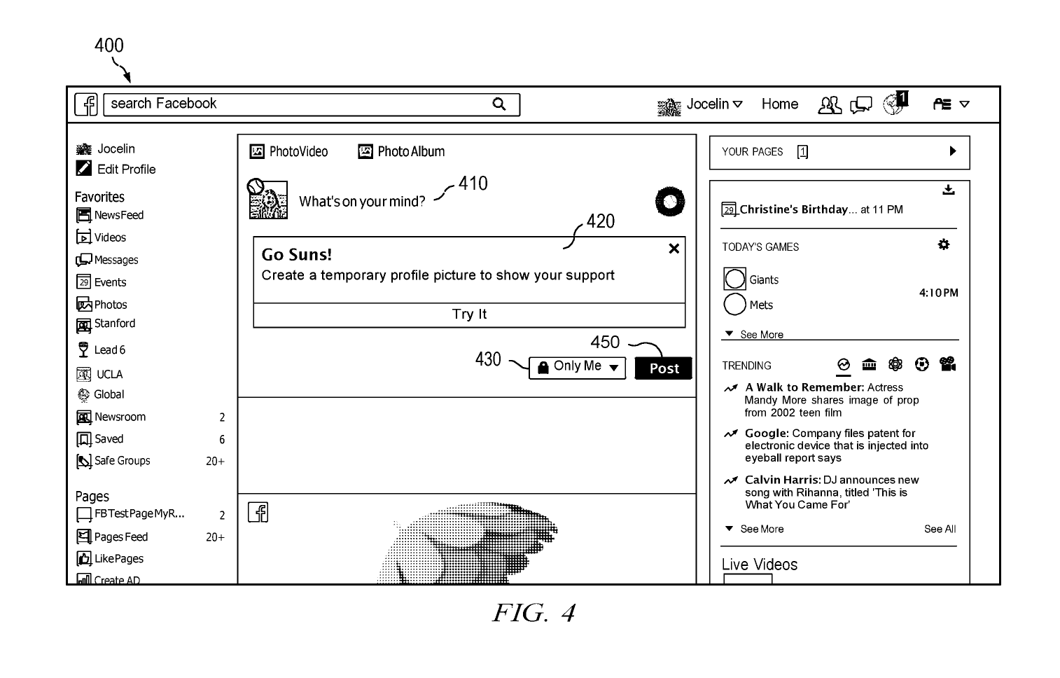

FIG. 4 illustrates an example user interface 400 for prompting a user to post a temporary profile picture. The user's profile picture may be an image associated with the user. User interface 400 may comprise user status update field 410, profile picture suggestion 420, visibility icon 430, and post icon 450. Profile picture suggestion 420 may comprise a text string that invites the user to change her profile picture temporarily. The motivation for temporarily changing a profile picture in the context of this disclosure may be to show support for a cause or entity associated with an event. If the event is an NBA basketball game in which the Phoenix Suns play, profile picture suggestion 420 may state: “Go Suns! Create a temporary profile picture to show your support!” If the event is a SPACEX rocket launch, the profile picture suggestion may state, “Create a temporary profile picture to show your support for SpaceX and the future of space travel.” If the user selects post icon 450, user interface 500 may be displayed.

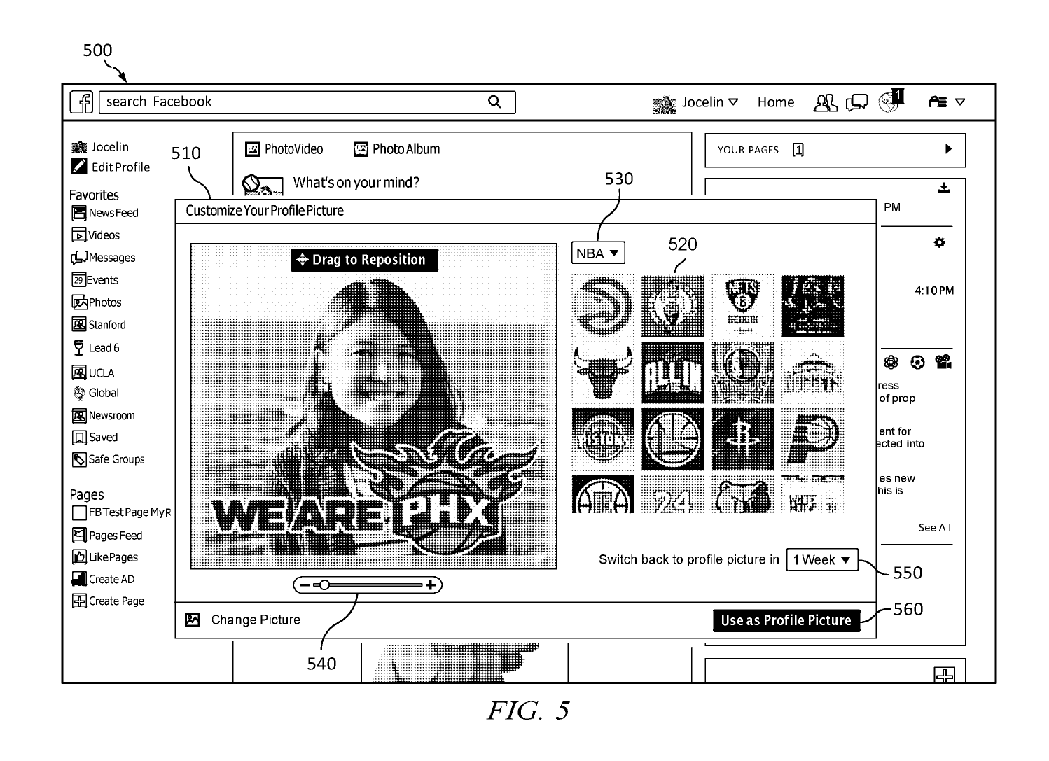

FIG. 5 illustrates an example user interface 500 for selecting a temporary user profile picture. User interface 500 may include temporary profile selection window 510, which may include temporary profile overlays 520, category selector 530, zoom selector 540, duration selector 550, and post icon 560. Temporary profile overlays 520 may include several different themes, teams, or other suitable graphical overlays to be overlaid on top of a user's current profile picture. Category selector 530 may include several different categories; each category may include temporary profile overlays related to different topics, wherein each topic corresponds to a particular category. As an example and not by way of limitation, if category selector 530 is set to “NBA,” temporary profile selection window 510 may display temporary profile overlays 520 associated with different NBA teams (e.g., Atlanta Hawks, Boston Celtics, Brooklyn Nets). The user may select a temporary profile overlay to be positioned on top of her current profile picture. Continuing the example, if the user selects the temporary profile overlay associated with the Phoenix Suns, that overlay may be displayed on top of the user's profile picture, as can be seen in FIG. 5. The user may slide the icon on zoom selector 540 to enlarge or shrink the temporary profile overlay 520. The user may also select a timeframe to display her new profile picture with duration selector 550. The timeframe may be the amount of time the new profile picture will be displayed before reverting back to the user's old profile picture (e.g., the profile picture the user had immediately before creating a temporary profile picture with user interface 500). The user may select as the timeframe 1 week, 2 weeks, 3 weeks, a month, or any amount of time the user desires. The user may also set the timeframe to indefinite, under which the new profile picture will remain until the user changes it. The user may set the new profile picture by selecting post icon 560.

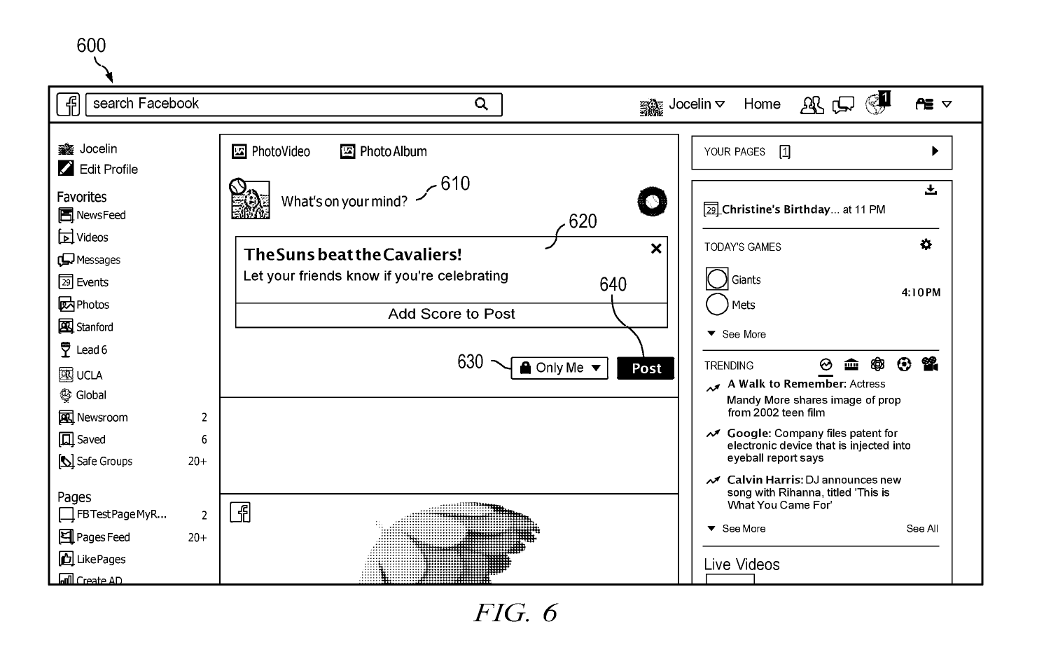

FIG. 6 illustrates an example user interface 600 for prompting a user to post a user status update. User interface 600 may be sent after an event has completed. User interface 600 may include user status update field 610, user status suggestion 620, visibility icon 630, and post icon 640. All the elements discussed with regard to previous figures may also be included in user interface 600 (e.g., minutiae, additional information, scores, highlights, headlines). User status suggestion 620 may comprise text, images, or video that indicates the event has taken place. As an example and not by way of limitation, if the event was an NBA Basketball game, user status suggestion 620 may state “The Suns beat the Cavaliers! Let your friends know you're celebrating.” The user may add the score and other highlights and statistics to the post. For example, the user may add a highlight video of a Suns player dunking the basketball over LeBron James or the stats of one or more star players. As another example, if the event was the SPACEX Falcon 9 successful landing, user status suggestion 620 may state, “History was made today. SpaceX successfully landed the Falcon 9 on an unmanned water station. Tell your friends about it.” The user may post this or any other suitable user status suggestion by selecting post icon 640.

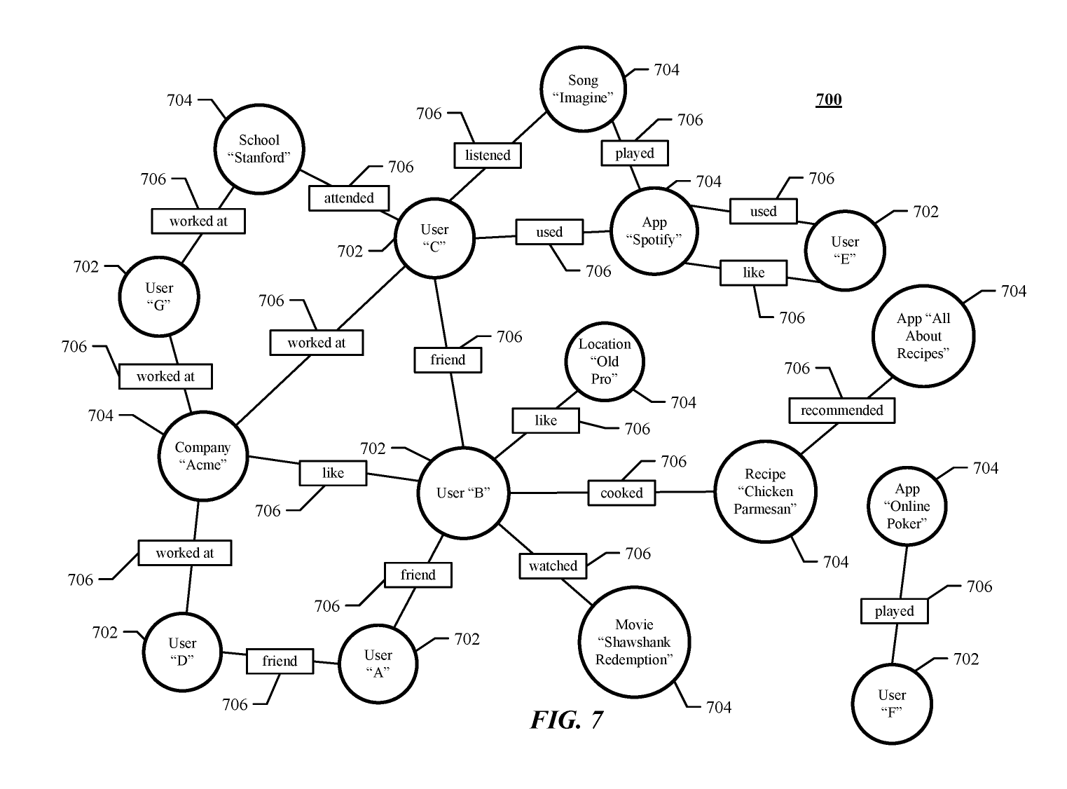

FIG. 7 illustrates example social graph 700. In particular embodiments, social-networking system 160 may store one or more social graphs 700 in one or more data stores. In particular embodiments, social graph 700 may include multiple nodes—which may include multiple user nodes 702 or multiple concept nodes 704—and multiple edges 706 connecting the nodes. Example social graph 700 illustrated in FIG. 7 is shown, for didactic purposes, in a two-dimensional visual map representation. In particular embodiments, a social-networking system 160, client system 130, or third-party system 170 may access social graph 700 and related social-graph information for suitable applications. The nodes and edges of social graph 700 may be stored as data objects, for example, in a data store (such as a social-graph database). Such a data store may include one or more searchable or queryable indexes of nodes or edges of social graph 700.

In particular embodiments, a user node 702 may correspond to a user of social-networking system 160. As an example and not by way of limitation, a user may be an individual (human user), an entity (e.g., an enterprise, business, or third-party application), or a group (e.g., of individuals or entities) that interacts or communicates with or over social-networking system 160. In particular embodiments, when a user registers for an account with social-networking system 160, social-networking system 160 may create a user node 702 corresponding to the user, and store the user node 702 in one or more data stores. Users and user nodes 702 described herein may, where appropriate, refer to registered users and user nodes 702 associated with registered users. In addition or as an alternative, users and user nodes 702 described herein may, where appropriate, refer to users that have not registered with social-networking system 160. In particular embodiments, a user node 702 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 702 may be associated with one or more data objects corresponding to information associated with a user. In particular embodiments, a user node 702 may correspond to one or more webpages.

In particular embodiments, a concept node 704 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 704 may be associated with information of a concept provided by a user or information gathered by various systems, including social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 704 may be associated with one or more data objects corresponding to information associated with concept node 704. In particular embodiments, a concept node 704 may correspond to one or more webpages.

In particular embodiments, a node in social graph 700 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 704. Profile pages may be viewable by all or a selected subset of other users. As an example and not by way of limitation, a user node 702 may have a corresponding user-profile page in which the corresponding user may add content, make declarations, or otherwise express himself or herself. As another example and not by way of limitation, a concept node 704 may have a corresponding concept-profile page in which one or more users may add content, make declarations, or express themselves, particularly in relation to the concept corresponding to concept node 704.

In particular embodiments, a concept node 704 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 130 to send to social-networking system 160 a message indicating the user's action. In response to the message, social-networking system 160 may create an edge (e.g., a check-in-type edge) between a user node 702 corresponding to the user and a concept node 704 corresponding to the third-party webpage or resource and store edge 706 in one or more data stores.

In particular embodiments, a pair of nodes in social graph 700 may be connected to each other by one or more edges 706. An edge 706 connecting a pair of nodes may represent a relationship between the pair of nodes. In particular embodiments, an edge 706 may include or represent one or more data objects or attributes corresponding to the relationship between a pair of nodes. As an example and not by way of limitation, a first user may indicate that a second user is a “friend” of the first user. In response to this indication, social-networking system 160 may send a “friend request” to the second user. If the second user confirms the “friend request,” social-networking system 160 may create an edge 706 connecting the first user's user node 702 to the second user's user node 702 in social graph 700 and store edge 706 as social-graph information in one or more of data stores 164. In the example of FIG. 7, social graph 700 includes an edge 706 indicating a friend relation between user nodes 702 of user “A” and user “B” and an edge indicating a friend relation between user nodes 702 of user “C” and user “B.” Although this disclosure describes or illustrates particular edges 706 with particular attributes connecting particular user nodes 702, this disclosure contemplates any suitable edges 706 with any suitable attributes connecting user nodes 702. As an example and not by way of limitation, an edge 706 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 700 by one or more edges 706.

In particular embodiments, an edge 706 between a user node 702 and a concept node 704 may represent a particular action or activity performed by a user associated with user node 702 toward a concept associated with a concept node 704. As an example and not by way of limitation, as illustrated in FIG. 7, a user may “like,” “attended,” “played,” “listened,” “cooked,” “worked at,” or “watched” a concept, each of which may correspond to an edge type or subtype. A concept-profile page corresponding to a concept node 704 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 160 may create a “listened” edge 706 and a “used” edge (as illustrated in FIG. 7) between user nodes 702 corresponding to the user and concept nodes 704 corresponding to the song and application to indicate that the user listened to the song and used the application. Moreover, social-networking system 160 may create a “played” edge 706 (as illustrated in FIG. 7) between concept nodes 704 corresponding to the song and the application to indicate that the particular song was played by the particular application. In this case, “played” edge 706 corresponds to an action performed by an external application (SPOTIFY) on an external audio file (the song “Imagine”). Although this disclosure describes particular edges 706 with particular attributes connecting user nodes 702 and concept nodes 704, this disclosure contemplates any suitable edges 706 with any suitable attributes connecting user nodes 702 and concept nodes 704. Moreover, although this disclosure describes edges between a user node 702 and a concept node 704 representing a single relationship, this disclosure contemplates edges between a user node 702 and a concept node 704 representing one or more relationships. As an example and not by way of limitation, an edge 706 may represent both that a user likes and has used at a particular concept. Alternatively, another edge 706 may represent each type of relationship (or multiples of a single relationship) between a user node 702 and a concept node 704 (as illustrated in FIG. 7 between user node 702 for user “E” and concept node 704 for “SPOTIFY”).

In particular embodiments, social-networking system 160 may create an edge 706 between a user node 702 and a concept node 704 in social graph 700. As an example and not by way of limitation, a user viewing a concept-profile page (such as, for example, by using a web browser or a special-purpose application hosted by the user's client system 130) may indicate that he or she likes the concept represented by the concept node 704 by clicking or selecting a “Like” icon, which may cause the user's client system 130 to send to social-networking system 160 a message indicating the user's liking of the concept associated with the concept-profile page. In response to the message, social-networking system 160 may create an edge 706 between user node 702 associated with the user and concept node 704, as illustrated by “like” edge 706 between the user and concept node 704. In particular embodiments, social-networking system 160 may store an edge 706 in one or more data stores. In particular embodiments, an edge 706 may be automatically formed by social-networking system 160 in response to a particular user action. As an example and not by way of limitation, if a first user uploads a picture, watches a movie, or listens to a song, an edge 706 may be formed between user node 702 corresponding to the first user and concept nodes 704 corresponding to those concepts. Although this disclosure describes forming particular edges 706 in particular manners, this disclosure contemplates forming any suitable edges 706 in any suitable manner.

In particular embodiments, an advertisement may be text (which may be HTML-linked), one or more images (which may be HTML-linked), one or more videos, audio, other suitable digital object files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social-networking system 160). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social-networking system 160 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social-networking system 160) or RSVP (e.g., through social-networking system 160) to an event associated with the advertisement. In addition or as an alternative, an advertisement may include social-networking-system content directed to the user. As an example and not by way of limitation, an advertisement may display information about a friend of the user within social-networking system 160 who has taken an action associated with the subject matter of the advertisement.

In particular embodiments, social-networking system 160 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 170 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 160 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of a observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 160 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 160 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 160 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 160 may calculate a coefficient based on a user's actions. Social-networking system 160 may monitor such actions on the online social network, on a third-party system 170, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 160 may calculate a coefficient based on the user's actions with particular types of content. The content may be associated with the online social network, a third-party system 170, or another suitable system. The content may include users, profile pages, posts, news stories, headlines, instant messages, chat room conversations, emails, advertisements, pictures, video, music, other suitable objects, or any combination thereof. Social-networking system 160 may analyze a user's actions to determine whether one or more of the actions indicate an affinity for subject matter, content, other users, and so forth. As an example and not by way of limitation, if a user frequently posts content related to “coffee” or variants thereof, social-networking system 160 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 160 may calculate a coefficient based on the type of relationship between particular objects. Referencing the social graph 700, social-networking system 160 may analyze the number and/or type of edges 706 connecting particular user nodes 702 and concept nodes 704 when calculating a coefficient. As an example and not by way of limitation, user nodes 702 that are connected by a spouse-type edge (representing that the two users are married) may be assigned a higher coefficient than a user nodes 702 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 160 may determine that the user has a higher coefficient with respect to the first photo than the second photo because having a tagged-in-type relationship with content may be assigned a higher weight and/or rating than having a like-type relationship with content. In particular embodiments, social-networking system 160 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 160 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 700. As an example and not by way of limitation, social-graph entities that are closer in the social graph 700 (i.e., fewer degrees of separation) may have a higher coefficient than entities that are further apart in the social graph 700.

In particular embodiments, social-networking system 160 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 130 of the user). A first user may be more interested in other users or concepts that are closer to the first user. As an example and not by way of limitation, if a user is one mile from an airport and two miles from a gas station, social-networking system 160 may determine that the user has a higher coefficient for the airport than the gas station based on the proximity of the airport to the user.

In particular embodiments, social-networking system 160 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 160 may provide information that is relevant to user's interests and current circumstances, increasing the likelihood that they will find such information of interest. In particular embodiments, social-networking system 160 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 160 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 160 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 170 (e.g., via an API or other communication channel), or from another suitable system. In response to the request, social-networking system 160 may calculate the coefficient (or access the coefficient information if it has previously been calculated and stored). In particular embodiments, social-networking system 160 may measure an affinity with respect to a particular process. Different processes (both internal and external to the online social network) may request a coefficient for a particular object or set of objects. Social-networking system 160 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 204 corresponding to a particular photo may have a privacy setting specifying that the photo may only be accessed by users tagged in the photo and their friends. In particular embodiments, privacy settings may allow users to opt in or opt out of having their actions logged by social-networking system 160 or shared with other systems (e.g., third-party system 170). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 170, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 162 may be authorization/privacy servers for enforcing privacy settings. In response to a request from a user (or other entity) for a particular object stored in a data store 164, social-networking system 160 may send a request to the data store 164 for the object. The request may identify the user associated with the request and may only be sent to the user (or a client system 130 of the user) if the authorization server determines that the user is authorized to access the object based on the privacy settings associated with the object. If the requesting user is not authorized to access the object, the authorization server may prevent the requested object from being retrieved from the data store 164, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

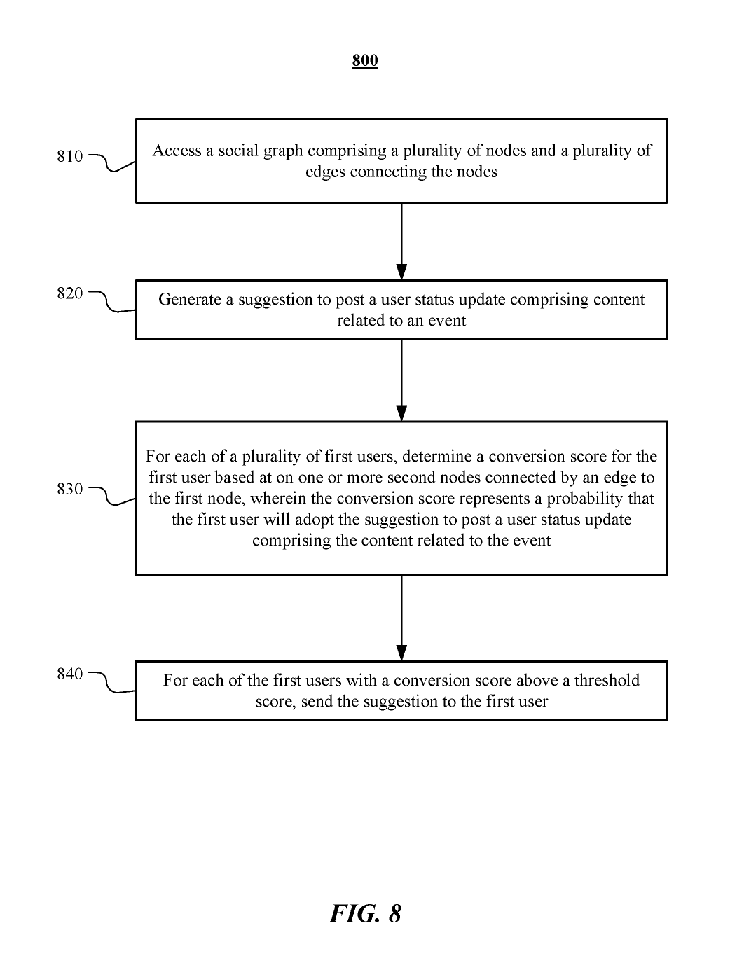

FIG. 8 illustrates an example method 800 for prompting a user to post a user status update comprising content related to an event. The method may begin at step 810, where social-networking 160 may access a social graph comprising a plurality of nodes and a plurality of edges connecting the nodes. At step 820, where social-networking 160 may generate a suggestion to post a user status update comprising content related to an event. At step 830, where social-networking 160 may, for each of a plurality of first users, determine a conversion score for the first user based at on one or more second nodes connected by an edge to the first node, wherein the conversion score represents a probability that the first user will adopt the suggestion to post a user status update comprising the content related to the event. At step 840, social-networking 160 may, for each of the first users with a conversion score above a threshold score, send the suggestion to the first user. Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for prompting a user to post a user status update comprising content related to an event including the particular steps of the method of FIG. 8, this disclosure contemplates any suitable method for prompting a user to post a user status update comprising content related to an event, including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

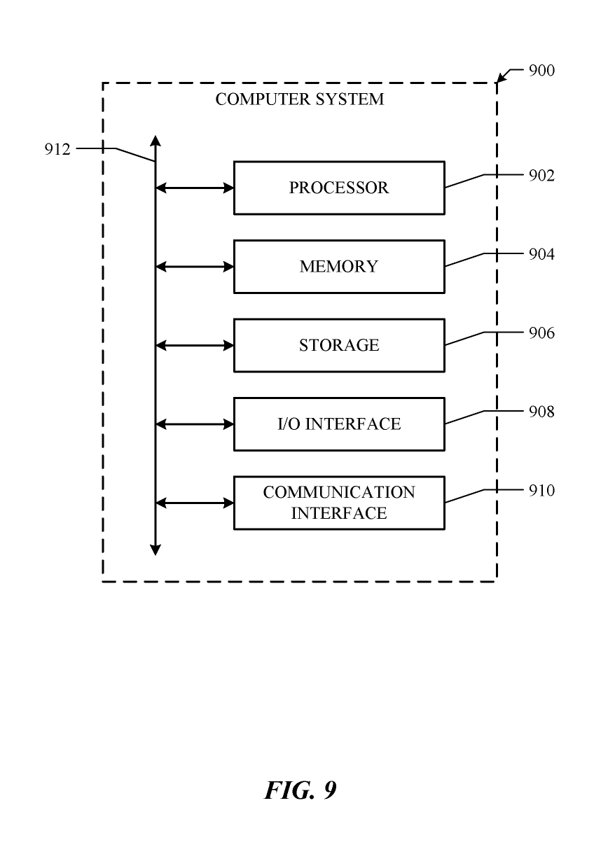

FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
by one or more computer server machines, generating a suggestion to post a user status update comprising content related to an event;
by the one or more computer server machines, for each of the plurality of first users, determining a conversion score for the first user based at least in part on information in association with one or more nodes or edges of a social graph associated with the user and maintained by an online social-networking system, wherein the conversion score represents a probability that the first user will post a user status update comprising the content related to the event; and
by the one or more computer server machines, for each of the first users with a conversion score above a threshold score, sending the suggestion to the first user.

2. The method of claim 1, further comprising:
receiving an indication that the first user has posted a user status update comprising the content related to the event; and
updating a status element of the first user with the content related to the event.

3. The method of claim 1, wherein the social graph comprises a plurality of nodes and a plurality of edges connecting the nodes, and wherein:
a first node of the plurality of nodes corresponds to the first user of the plurality of users;
each of one or more second nodes of the plurality of nodes corresponds to a second user, an entity, or a content object, wherein at least some of the second nodes are connected by an edge to the first node; and
each edge of the plurality of edges corresponds to a relationship between two nodes of the plurality of nodes;
by the one or more computer server machines,

4. The method of claim 3, wherein the conversion score is calculated by:
measuring an affinity coefficient between the first node and each of the one or more second nodes, wherein the affinity coefficient represents a strength of a relationship between two nodes; and
applying one or more weighting factors to each of the affinity coefficients.

5. The method of claim 4, wherein the affinity coefficient is based on the first user liking, sharing, commenting on, or clicking on a content object corresponding to a second node.

6. The method of claim 4, wherein the conversion score for the first user represents a sum of the product of each affinity coefficient and its respective weighting factor.

7. The method of claim 4, wherein the weighting factors are determined by a machine learning model comprising a plurality of inputs, wherein the plurality of inputs comprise:
a time of day that the event occurs;
whether the first user has previously adopted a suggestion to post a user status update;
an affinity score between the first node and a second node corresponding to the event; and
a frequency with which the first user posts user status updates.

8. The method of claim 4, wherein the weighting factors are determined at least in part by an affinity coefficient between the first node and a second node corresponding to the event, and at least one sub-event occurring within the event.

9. The method of claim 1, wherein the event is a sporting event, a scheduled television broadcast, or a live event.

10. The method of claim 1, wherein the suggestion is sent prior to the event or during the event.

11. The method of claim 1, wherein the content related to the event comprises minutiae relating to the user, wherein the minutiae describes the first user's sentiment or activity during the event.

12. One or more computer-readable non-transitory storage media embodying software that is operable when executed to:
generate a suggestion to post a user status update comprising content related to an event;
for each of the plurality of first users, determine a conversion score for the first user based at least in part on information in association with one or more nodes or edges of a social graph associated with the user and maintained by an online social-networking system, wherein the conversion score represents a probability that the first user will post a user status update comprising the content related to the event; and
for each of the first users with a conversion score above a threshold score, send the suggestion to the first user.

13. The media of claim 12, wherein the software is further operable when executed to:
receive an indication that the first user has posted a user status update comprising the content related to the event; and
update a status element of the first user with the content related to the event.

14. The media of claim 12, wherein the social graph comprises a plurality of nodes and a plurality of edges connecting the nodes, wherein:
a first node of the plurality of nodes corresponds to the first user of the plurality of users;
each of one or more second nodes of the plurality of nodes corresponds to a second user, an entity, or a content object, wherein at least some of the second nodes are connected by an edge to the first node; and
each edge of the plurality of edges corresponds to a relationship between two nodes of the plurality of nodes;

15. The media of claim 14, wherein the conversion score is calculated by:
measuring an affinity coefficient between the first node and each of the one or more second nodes, wherein the affinity coefficient represents a strength of a relationship between two nodes; and
applying one or more weighting factors to each of the affinity coefficients.

16. The media of claim 15, wherein the affinity coefficient is based on the first user liking, sharing, commenting on, or clicking on a content object corresponding to a second node.

17. The media of claim 15, wherein the conversion score for the first user represents a sum of a product of each affinity coefficient and its respective weighting factor.

18. The media of claim 15, wherein the weighting factors are determined by a machine learning model comprising a plurality of inputs, wherein the plurality of inputs comprise:
a time of day that the event occurs;
whether the first user has previously adopted a suggestion to post a user status update;
an affinity score between the first node and a second node corresponding to the event; and
a frequency with which the first user posts user status updates.

19. A system comprising: one or more processors; and a memory coupled to the processors comprising instructions executable by the processors, the processors being operable when executing the instructions to:
generate a suggestion to post a user status update comprising content related to an event;
for each of the plurality of first users, determine a conversion score for the first user based at least in part on information in association with one or more nodes or edges of a social graph associated with the user and maintained by an online social-networking system, wherein the conversion score represents a probability that the first user will post a user status update comprising the content related to the event; and
for each of the first users with a conversion score above a threshold score, send the suggestion to the first user.

20. The system of claim 19, wherein the processors are further operable when executing the instructions to:
receive an indication that the first user has posted a user status update comprising the content related to the event; and
update a status element of the first user with the content related to the event.
